(19) United States
(12) Patent Application Publication
(10) Pub. No.: US 2005/0182868 A1
(43) Pub. Date: Aug. 18, 2005

(54) Apparatus and method for controlling memory

(75) Inventor: Shin-wook Kang, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., LTD., Suwon-si (KR)

(21) Appl. No.: 11/059,467

(22) Filed: Feb. 16, 2005

(30) Foreign Application Priority Data
Feb. 17, 2004 (KR) 2004-10408

(51) Int. Cl. G06F 13/00

(52) U.S. Cl. 710/35; 710/305

(57) ABSTRACT

An apparatus and method for controlling access to a memory to minimize a latency in a bus system when there is a wrapping burst request from a bus. The apparatus includes a first detecting unit detecting a burst length in a wrapping burst instruction received from the bus master when the command received from the bus master is the wrapping burst instruction, a second detecting unit detecting in the received wrapping burst instruction a start address of a region of the memory to be accessed when the command received from the bus master is the wrapping burst instruction, and a finite state machine (FSM) detecting an address to be wrapped based on the detection results of the first and the second detecting units and generating signals for controlling the memory to output a CAS command of the address to be wrapped.

### CROSS-REFERENCE TO RELATED APPLICATIONS

This application claims the benefit of Korean Patent Application No. 10-2004-0010408, filed on Feb. 17, 2004, in the Korean Intellectual Property Office, the disclosure of which is incorporated herein in its entirety by reference.

### BACKGROUND OF THE INVENTION

1. Field of the Invention

Embodiments of the present invention relate to memory access, and more particularly, to an apparatus and method for controlling a memory in which the memory can be accessed in response to a wrapping burst instruction generated by a bus master.

2. Description of the Related Art

In general, a bus master is a processor, such as a CPU (Central Processing Unit) core. In a system having multiple masters, the bus master can be treated as an individual master. The bus master operates by accessing data of a memory included in the system.

The memory stores programs and/or data necessary to operate the bus master. The memory may be a volatile memory, such as a DRAM (Dynamic RAM), or a non-volatile memory, such as a flash memory. In a system having multiple masters, the memory can also be shared by the multiple masters.

The bus master can access the memory by a sequential burst or a wrapping burst. A wrapping burst is referred to as an “interleave burst.” When the bus master accesses the memory by a sequential burst, the bus master receives data having a burst length in which the order of accessing the memory is arranged sequentially. Alternatively, if the bus master accesses the memory based on the wrapping burst, the bus master will receive data having a burst length where the order of accessing the memory was wrapped on the basis of an initial start address.

Conventionally, when the bus master accesses the memory based on the wrapping burst, a bus logic or a memory controlling apparatus, provided between the bus master and the memory, arranges the order in which the data is to be accessed by buffering sequentially accessed data rom the memory, or the memory controlling apparatus controls the memory to output data accessed according to the wrapping burst mode, by performing a Mode Register Set (MRS) procedure with respect to the memory.

However, in this wrapping burst mode, using buffering, the latency for transferring data is generated by the buffering, and in wrapping burst mode, by performing the MRS procedure, the latency is further caused by performing the MRS procedure. In particular, in the method of performing the MRS procedure, the latency caused by the MRS procedure also occurs in the normal mode since the MRS procedure with respect to the memory should be performed again when a mode of the memory that is operated in the wrapping burst mode is changed into a normal mode.

### SUMMARY OF THE INVENTION

Embodiments of the present invention provide an apparatus and method for controlling a memory such that it is possible to minimize the latency when accessing a memory.

Embodiments of the present invention also provides an apparatus and method for controlling a memory such that a memory is accessed with the least latency, in response to a wrapping burst request of a bus master.

Additional aspects and/or advantages of the invention will be set forth in part in the description which follows and, in part, will be obvious from the description, or may be learned by practice of the invention.

To achieve the above and/or other aspects and advantages, embodiments of the present invention set forth an apparatus for controlling a memory, including a first detecting unit detecting a burst length in a wrapping burst instruction received from a bus master, a second detecting unit detecting in the received wrapping burst instruction a start address of a region of a memory, and a finite state machine (FSM) detecting an address to be wrapped based on detection results of the first and the second detecting units and generating signals controlling the memory to output a column address strobe (CAS) command of the address to be wrapped.

The FSM may perform a state transition to sequentially generate a row address strobe (RAS) command of the memory region, a CAS command of the start address, and the CAS command of the address to be wrapped.

The apparatus for controlling the memory may further include command analysis unit determining whether a command received from the bus master is the wrapping burst instruction. In addition, the apparatus may still further include a memory interface transferring the received CAS command to the memory based on the generated signals and transferring data accessed from the memory to the bus master.

To achieve the above and/or other aspects and advantages, embodiments of the present invention set forth an apparatus for controlling a memory, including a first detecting unit detecting a burst length from a wrapping burst instruction received from a cache memory of a requesting processor, a second detecting unit detecting, in the wrapping burst instruction received from the cache memory, a start address of a region of a memory, and a FSM detecting an address to be wrapped based on detection results of the first and the second detecting units and generating signals fcontrolling the memory to output a column address strobe (CAS) command of the address to be wrapped.

To achieve the above and/or other aspects and advantages, embodiments of the present invention set forth a method of controlling access to a memory, including detecting a burst length in a wrapping burst instruction received from a bus master, detecting, in the received wrapping burst instruction, a start address of a region of a memory, detecting an address to be wrapped based on the detected burst length and start address, and generating signals controlling the memory to output a column address strobe (CAS) command corresponding to the address to be wrapped.

In the generating of the signals controlling the memory to output the CAS command corresponding to the address to be wrapped, a row address strobe (RAS) command, corresponding to the region of the memory, a CAS command corresponding to the start address of the region, and a CAS command corresponding to the address to be wrapped may be sequentially generated.

The method may further include determining whether a command received from the bus master is the wrapping burst instruction.

To achieve the above and/or other aspects and advantages, embodiments of the present invention set forth a system, including a bus master, an apparatus for controlling a memory according to embodiments of the present invention, and the memory.

To achieve the above and/or other aspects and advantages, embodiments of the present invention set forth a method of accessing a memory, including requesting data from a memory through a data request signal from a bus master, detecting a burst length in the data request signal, with the data request signal comprising a wrapping burst instruction, received from the bus master, detecting, in the received wrapping burst instruction, a start address of a region of a memory, detecting an address to be wrapped based on the detected burst length and start address, and generating signals controlling the memory to output a column address strobe (CAS) command corresponding to the address to be wrapped.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a system having a memory controlling apparatus, according to an embodiment of the present invention;

FIG. 2 is a functional block diagram of a memory controlling apparatus, according to an embodiment of the present invention;

FIG. 3 is a timing diagram explaining an operation of a memory controlling apparatus, according to an embodiment of the present invention, in response to a wrapping burst instruction having a burst length of 4 and a start address of 2;

FIG. 4 is a timing diagram explaining an operation of a memory controlling apparatus, according to an embodiment of the present invention, in response to a wrapping burst instruction having a burst length of 4 and a start address of 3;

FIG. 5 is a timing diagram explaining an operation of a memory controlling apparatus, according to an embodiment of the present invention, in response to a wrapping burst instruction having a burst length of 4 and a start address of 4; and

FIG. 6 is a flowchart of a method of controlling a memory, according to an embodiment of the present invention.

### DETAILED DESCRIPTION OF THE PREFERRED EMBODIMENTS

Reference will now be made in detail to embodiments of the present invention, examples of which are illustrated in the accompanying drawings, wherein like reference numerals refer to the like elements throughout. The embodiments are described below to explain the present invention by referring to the figures.

FIG. 1 is a functional block diagram of a system having a memory controlling apparatus, according to an embodiment of the present invention. Referring to FIG. 1, the system includes a bus master 100, a memory controlling apparatus 110 and a memory 120.

The bus master 100 is a processor, such as a CPU (Central Processing Unit) core. The bus master 100 is authorized to use a bus system formed between the memory 120 and the bus master 100. If the system has multiple masters, then the bus master 100 may be a processor other than the CPU core included in the system. A bus master 100 may also include a cache memory 105.

The cache memory 105 is generally a SRAM (Static RAM) based memory. The cache memory 105 buffers the speed difference between the bus master 100 and the memory 120. Thus, when data request signals are generated by the bus master 100, the data request signals are transferred to the cache memory 105. If the data requested by the bus master 100 does not exist in the cache memory 105, the cache memory 105 outputs memory accessing request signals to the memory controlling apparatus 110.

The bus master 100 may not include the cache memory 105. If the bus master 100 does not include the cache memory 105, the data request signals generated by the bus master 100 can be output directly to the memory controlling apparatus 110.

The data request signals are commands including the OP code, information defining a sequence burst mode or a wrapping burst mode, burst length information, information on a region of the memory 120 to be accessed, and read or write mode information. The burst length has a usable burst length in the relevant bus system.

When the command is received, the memory controlling apparatus 110 analyzes the received command, outputs memory controlling signals to the memory 120 based on the result of analyzing, and transfers the data accessed from the memory 120 to the bus master 100.

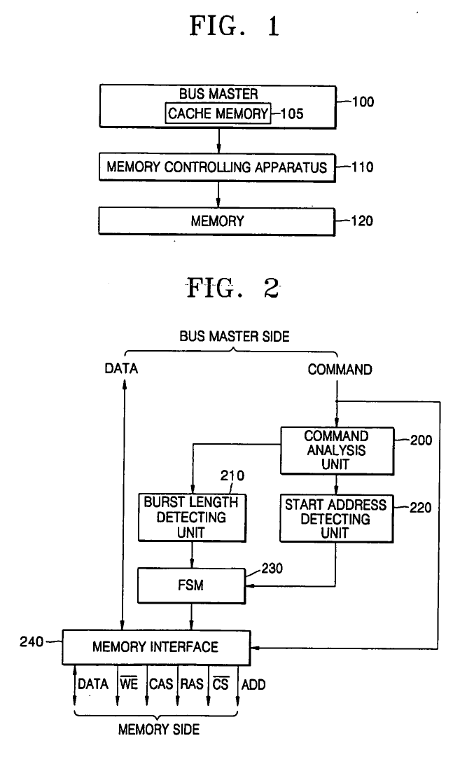

To this end, the memory controlling apparatus 110 is can be arranged as illustrated in FIG. 2. Referring to FIG. 2, the memory controlling apparatus 110 includes a command analysis unit 200, a burst length detecting unit 210, a start address detecting unit 220, a finite state machine (FSM) 230, and a memory interface 240.

When a command including the above-mentioned information is received, the command analysis unit 200 analyzes the information included in the received command. If the received command is a wrapping burst instruction, the command analysis unit 200 transmits the received command to the burst length detecting unit 210 and the start address detecting unit 220, while controlling the burst length detecting unit 210 and the start address detecting unit 220 in an active mode.

The burst length detecting unit 210 detects a burst length for information, which the bus master 100 will access based on the burst length included in the command. The detected burst length information is transferred to the FSM 230.

The start address detecting unit 220 detects a start address included in the command received in the wrapping burst mode. Like the burst length information, the start address is detected in the command transferred using a protocol of a bus system. Accordingly, the start address detecting unit 220 detects the start address in the command received, using the protocol of the bus system, and transmits information regarding a starting point of the detected start address to the FSM 230.

The FSM 230 generates control signals for accessing a memory 120 based on the detection results transferred from the burst length detecting unit 210 and the start address detecting unit 220. In particular, the FSM 230 generates a RAS (row address strobe) command corresponding to a region of the memory to be accessed, a CAS (column address strobe) command corresponding to a start address, an address to be wrapped and a CAS command corresponding to the address, signals controlling CAS latency and precharge time, etc. To generate these signals, the FSM 230 makes transitions among an idle state, a RAS state, a CAS state and a precharge state.

The FSM 230 makes transitions among the above-identified states such that the RAS command of a memory region to be accessed, the CAS command of the start address, and the CAS command of an address to be wrapped can be sequentially generated.

Based on the control/status signals and a command received from the FSM 230, a memory interface 240 transmits an address (ADD), a chip select signal (CS), a RAS command, a CAS command and a write enable (WE) signal to the memory 120. Thus, when data read from the memory 120 is received, the received data is transferred to the bus master 100 without a delay. In FIG. 2 the addresses are illustrated as being focused on the conceptional operation of the memory controlling apparatus 110. The address includes an address bit, a specific bit and a bank select bit.

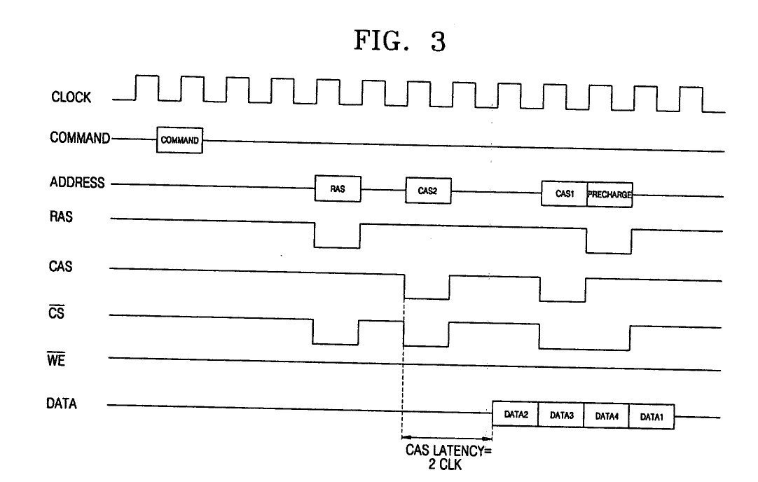

FIG. 3 is a timing diagram of signals output to the memory 120 from the memory interface 240 and data accessed in the memory 120, when a wrapping burst instruction, having a burst length of ‘4’ and a start address of ‘2’, is received from the bus master 100, and for illustrating read operations of the memory 120. As shown in FIG. 3, after a RAS command corresponding to a region of the memory to be accessed is output, a CAS command corresponding to a start address (or the first address) is output, and subsequently a CAS command corresponding to an address to be wrapped is output. FIG. 3 is a timing diagram when the CAS latency is 2 clock cycles and the precharge time is 2 clock cycles. However, both the CAS latency and the precharge time may be set to 1 clock cycle. Therefore, in FIG. 3, data accessed in the memory 120 in the order of “Data 2”, “Data 3”, “Data 4” and “Data 1” is provided to the bus master 100.

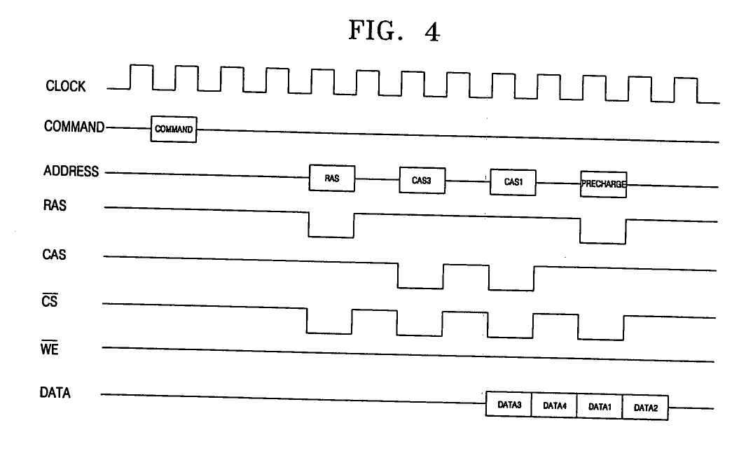

FIG. 4 is a timing diagram of signals output to the memory 120 from the memory interface 240 and data accessed in the memory 120 when a wrapping-burst instruction, having a burst length of ‘4’ and a start address of ‘3’, is received from the bus master 100, and for illustrating read operations of the memory 120. As shown in FIG. 4, after a RAS command corresponding to a region of memory to be accessed is output, a CAS command corresponding to a start address (or the first address) is output, and subsequently a CAS command corresponding to an address to be wrapped is output. FIG. 4 is a timing diagram when the CAS latency is 2 clock cycles and the precharge time is 2 clock cycles. However, both the CAS latency and the precharge time may be set to be 1 clock cycle. Thus, in FIG. 4, data accessed from a memory 120 in the order of “Data 3”, “Data 4”, “Data 1” and “Data 2” is provided to the bus master 100.

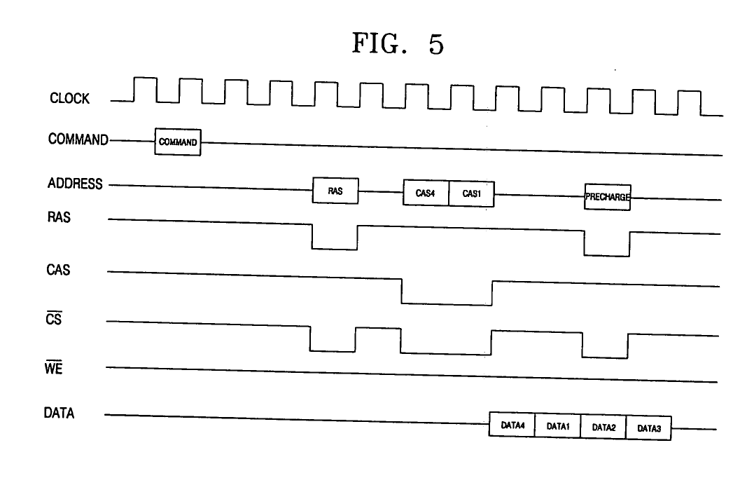

FIG. 5 is a timing diagram of signals output to the memory 120 from the memory interface 240 and data accessed in the memory 120 when a wrapping burst instruction, having a burst length of ‘4’ and a start address of ‘4’, is received from the bus master 100, and for illustrating read operations of the memory 120. As shown in FIG. 5, after a RAS command corresponding to a region of the memory to be accessed is output, a CAS command corresponding to a start address (or the first address) is output, and subsequently a CAS command corresponding to an address to be wrapped is output. FIG. 5 is a timing diagram when the CAS latency is 2 clock cycles and the precharge time is 2 clock cycles. However, the CAS latency and the precharge time may be set to 1 clock cycle. Thus, in FIG. 5, data accessed in the memory 120 in the order of “Data 4”, “Data 1”, “Data 2” and “Data 3” is provided to the bus master 100.

The memory 120 may stores programs or data necessary to operate the bus master 100. The memory 120 may be a volatile memory, such as a DRAM, or a non-volatile memory, such as a flash memory. In a system having multiple masters (not shown), the memory 120 can be shared by the multiple masters. If the memory 120 is a SDRAM (static DRAM), the memory controlling apparatus 110 is an SDRAM controller.

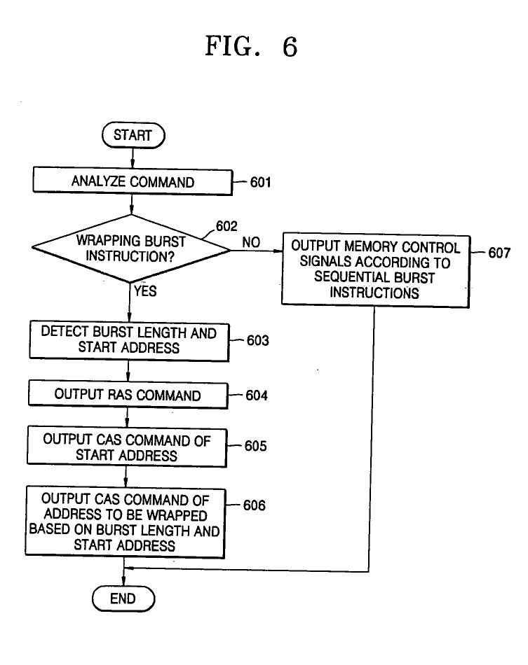

FIG. 6 is a flowchart of a method of controlling a memory, according to an embodiment of the present invention.

Referring to FIG. 6, when a command is received from the bus master 100, the received command is analyzed, in operation 601. The received command includes information described above with reference to FIG. 2.

When it is determined, in operation 602, that a wrapping burst instruction is received from the bus master 100 based on the result of the analyzing of the command, a burst length and a start address of a wrapping burst are detected in the received instruction, in operation 603.

Based on the detected burst length and start address, a RAS command corresponding to a relevant region of the memory 120 is output, in operation 604.

A CAS command corresponding to the start address is output, in operation 605. If the burst length is 4 and the start address is 2, as in FIG. 3, the CAS command output in operation 605 sets the address to 2.

An address to be wrapped is detected based on the detected burst length and start address and the CAS command corresponding to the address is output, in operation 606.

As described above, data accessed from the memory 120 is provided to the bus master 100 as the RAS command and the CAS command are output.

Meanwhile, if the command received from the bus master 100 is not a wrapping burst instruction, in operation 602, memory controlling signals are output according to sequential burst instructions, in operation 607.

As described above, embodiments of the present invention provide an apparatus and method of controlling access to a memory by analyzing a command received from a bus master, which may be a processor such as a CPU core, when a wrapping burst is requested by the bus master, so that a latency in a bus system between the bus master and the memory can be reduced. If the bus master has a cache memory, the latency in the operation of the cache memory can be reduced.

Although a few embodiments of the present invention have been shown and described, it would be appreciated by those skilled in the art that changes may be made in these embodiments without departing from the principles and spirit of the invention, the scope of which is defined in the claims and their equivalents.

1. An apparatus for controlling a memory, comprising:
a first detecting unit detecting a burst length in a wrapping burst instruction received from a bus master;
a second detecting unit detecting in the received wrapping burst instruction a start address of a region of a memory; and
a finite state machine (FSM) detecting an address to be wrapped based on detection results of the first and the second detecting units and generating signals controlling the memory to output a column address strobe (CAS) command of the address to be wrapped.

2. The apparatus of claim 1, wherein the FSM performs a state transition to sequentially generate a row address strobe (RAS) command of the memory region, a CAS command of the start address, and the CAS command of the address to be wrapped.

3. The apparatus of claim 1, further comprising a command analysis unit determining whether a command received from the bus master is the wrapping burst instruction.

4. The apparatus of claim 1, further comprising a memory interface transferring the received CAS command to the memory based on the generated signals and transferring data accessed from the memory to the bus master.

5. An apparatus for controlling a memory, comprising:
a first detecting unit detecting a burst length from a wrapping burst instruction received from a cache memory of a requesting processor;
a second detecting unit detecting, in the wrapping burst instruction received from the cache memory, a start address of a region of a memory; and
a FSM detecting an address to be wrapped based on detection results of the first and the second detecting units and generating signals fcontrolling the memory to output a column address strobe (CAS) command of the address to be wrapped.

6. A method of controlling access to a memory, comprising:
detecting a burst length in a wrapping burst instruction received from a bus master; detecting, in the received wrapping burst instruction, a start address of a region of a memory;
detecting an address to be wrapped based on the detected burst length and start address; and
generating signals controlling the memory to output a column address strobe (CAS) command corresponding to the address to be wrapped.

7. The method of claim 6, wherein in the generating of the signals controlling the memory to output the CAS command corresponding to the address to be wrapped, a row address strobe (RAS) command, corresponding to the region of the memory, a CAS command corresponding to the start address of the region, and a CAS command corresponding to the address to be wrapped are sequentially generated.

8. The method of claim 6, further comprising determining whether a command received from the bus master is the wrapping burst instruction.

9. A system, comprising:
a bus master;
an apparatus for controlling a memory of claim 1; and
the memory.

10. A system, comprising:
a bus master comprising a processor and memory cache;
an apparatus for controlling a memory of claim 1; and
the memory.

11. A system, comprising:
a bus master comprising a processor and memory cache;
an apparatus for controlling a memory of claim 5; and
the memory.

12. A method of accessing a memory, comprising:
requesting data from a memory through a data request signal from a bus master;
detecting a burst length in the data request signal, with the data request signal comprising a wrapping burst instruction, received from the bus master;
detecting, in the received wrapping burst instruction, a start address of a region of a memory;
detecting an address to be wrapped based on the detected burst length and start address; and
generating signals controlling the memory to output a column address strobe (CAS) command corresponding to the address to be wrapped.
